(19) United States
(12) Patent Application Publication
(10) Pub. No.: US 2026/0017170 A1
(43) Pub. Date: Jan. 15, 2026

(54) CONTEXT AGGREGATION AND ASSOCIATION FOR CONTAINERIZED APPLICATIONS

(71) Applicant: Dell Products L.P., Round Rock, TX (US)

(72) Inventors: James Snyder, Rockledge, FL (US); Jason Liu, Wellesley, MA (US); Anthony Jreij, Pflugerville, TX (US); Matthew R. Cullen, Derry, NH (US)

(21) Appl. No.: 18/767,249

(22) Filed: Jul. 9, 2024

(51) Int. Cl. G06F 11/36

(52) U.S. Cl. CPC G06F 11/3608

(57) ABSTRACT

A system can perform static analysis of source code and at least one configuration file to identify dependencies of microservices of a microservices architecture, wherein the source code is configured to be executable as the microservices architecture, wherein the at least one configuration file comprises a key-value pair that identifies a resource of resources, and where the source code invokes the resource via at least part of the key-value pair. The system can create a dependency graph based on the dependencies, wherein respective nodes of the dependency graph represent corresponding respective resources of the resources, and wherein respective edges of the dependency graph represent corresponding respective dependencies of the dependencies between the respective resources. The system can display a graphical representation of the dependency graph in a user interface.

### BACKGROUND

A computer application can generally be implemented with a containerized architecture.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can perform static analysis of source code and at least one configuration file to identify dependencies of microservices of a microservices architecture, wherein the source code is configured to be executable as the microservices architecture, wherein the at least one configuration file comprises a key-value pair that identifies a resource of resources, and where the source code invokes the resource via at least part of the key-value pair. The system can create a dependency graph based on the dependencies, wherein respective nodes of the dependency graph represent corresponding respective resources of the resources, and wherein respective edges of the dependency graph represent corresponding respective dependencies of the dependencies between the respective resources. The system can display a graphical representation of the dependency graph in a user interface.

An example method can comprise performing, by a system comprising at least one processor, static analysis of source code and a configuration file of a microservices architecture to identify dependencies between resources of the microservices architecture, wherein the configuration file identifies the resources, and wherein the source code indicates invoking the resources. The method can further comprise creating, by the system, a dependency graph based on the dependencies, wherein respective nodes of the dependency graph represent corresponding respective microservices of the microservices, and wherein respective edges of the dependency graph represent corresponding respective dependencies between the respective microservices. The method can further comprise displaying, by the system, a graphical representation of the dependency graph in a user interface.

An example non-transitory computer-readable medium can comprise instructions that, in response to execution, cause a system comprising a processor to perform operations. These operations can comprise using a static analysis to analyze source code and a configuration file to identify dependencies between resources of a microservice architecture, wherein the configuration file identifies a resource, and wherein the source code is configured to invoke the resource. These operations can further comprise creating a dependency graph based on the dependencies, wherein respective nodes of the dependency graph represent corresponding respective microservices of the microservices, and wherein respective edges of the dependency graph represent corresponding respective dependencies between the respective microservices. These operations can further comprise rendering a representation of the dependency graph via a user interface.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate context aggregation and association for containerized applications, in accordance with an embodiment of this disclosure;

FIG. 2 illustrates another example system architecture that can facilitate context aggregation and association for containerized applications, in accordance with an embodiment of this disclosure;

FIG. 3 illustrates an example dependency graph that can facilitate context aggregation and association for containerized applications, in accordance with an embodiment of this disclosure;

FIG. 4 illustrates an example dependency graph that can facilitate context aggregation and association for containerized applications, in accordance with an embodiment of this disclosure;

FIG. 5 illustrates an example dependency graph that can facilitate context aggregation and association for containerized applications, in accordance with an embodiment of this disclosure;

FIG. 6 illustrates an example dependency graph that can facilitate context aggregation and association for containerized applications, in accordance with an embodiment of this disclosure;

FIG. 7 illustrates an example dependency graph that can facilitate context aggregation and association for containerized applications, in accordance with an embodiment of this disclosure;

FIG. 8 illustrates an example dependency graph that can facilitate context aggregation and association for containerized applications, in accordance with an embodiment of this disclosure;

FIG. 9 illustrates example pseudo code that can facilitate context aggregation and association for containerized applications, in accordance with an embodiment of this disclosure;

FIG. 10 illustrates an example configuration table that can facilitate context aggregation and association for containerized applications, in accordance with an embodiment of this disclosure;

FIG. 11 illustrates another example system architecture that can facilitate context aggregation and association for containerized applications, in accordance with an embodiment of this disclosure;

FIG. 12 illustrates an example process flow that can facilitate context aggregation and association for containerized applications, in accordance with an embodiment of this disclosure;

FIG. 13 illustrates another example process flow that can facilitate context aggregation and association for containerized applications, in accordance with an embodiment of this disclosure;

FIG. 14 illustrates another example process flow that can facilitate context aggregation and association for containerized applications, in accordance with an embodiment of this disclosure;

FIG. 15 illustrates an example block diagram of a computer operable to execute an embodiment of this disclosure.

### DETAILED DESCRIPTION

### Overview

A containerized application can generally comprise a computer application (e.g., one that offers remote data storage to computer clients) that is architected with multiple application components that are configured to interact, each application component executing in a container. A container can generally comprise an isolated environment in which application computer code is executed, where the container additionally comprises components that the computer code depends on, such as libraries, frameworks, and/or configuration files.

Scalable container-based platforms can have challenges. For example, some prior approaches can provide a scalable and faster software shipment with a capability to manage microservice architecture. There can be many logically isolated environments (which can be referred to as namespaces) provided to specific teams or specific releases for develop, production, or testing purposes. A challenge for working in such complex platform can be that human experts must carefully plan, execute, and troubleshoot to chase a dynamic changing business logic.

However, in such complex environments (which can include multi-cloud or hybrid-cloud environments), it can be that there is no easy way to know what sequence of activities should happen, what activities actually happen, and/or a correlation among “should” and “actually.”

While there can be add-on services to monitor activities within a platform, or even with anomaly detection models to detect abnormal behaviors, a problem can be that business logic that is supposed to drive activities is not easily accessible. For static business logic, the execution sequence in such container actives can be well known; however, for fast software development, multiple versions of the same containers can exhibit different behaviors within the same name space (e.g., A/B testing) or in different name spaces (e.g., dev, staging, and production).

For a large scale containerized application platform, for example, when there are 300 programmers and SRE experts working on different portions of the containers in the same platform in parallel, what should happen versus what actually happens can be difficult to know.

The present techniques can be implemented to address these problems.

Problems with prior approaches can be generally grouped into the following types. A problem can relate to intentional activities that are planned to happen. There can be business logic for what services there are and how they should work together, following particular sequences. This can be extended to needed resources (e.g., database tables, streamed channel topics, and software libraries and versions)

Another problem can relate to behavior results that can be observed and collected. It can be that this should be as complete as possible, and should include logging (e.g., system metrics, end user activities, service logs, backend database logs, source code testing logs at different stage, and configuration changes happened during the system operations).

Another problem can relate to isolated logging information, which can create confusion and frustrations for human experts if such information is not properly sorted and correlated into threads following causal/temporal relationships.

In some examples, the present techniques can be implemented to address a problem of intentional activities that are planned to happen, by facilitating capturing intentional business logic from source code. In particular, intentional business logic can be captured from a service dependency map.

The present techniques can be implemented to parse both static source code and static configuration files (e.g., key and value pairs) within a given microservice that is parsed.

Where the configuration files are parsed, those keys can be taken, and the source code can be parsed for their usage to determine a lower-level dependency map compared to other approaches.

Here, “lower-level” can generally comprise parsing static source code that leads to an execution of a source code line that uses that key's value (e.g., to call another microservice, a database, or a streaming event service). This can have an indirect reference to setting up a dependency map.

### Example Architectures, Etc.

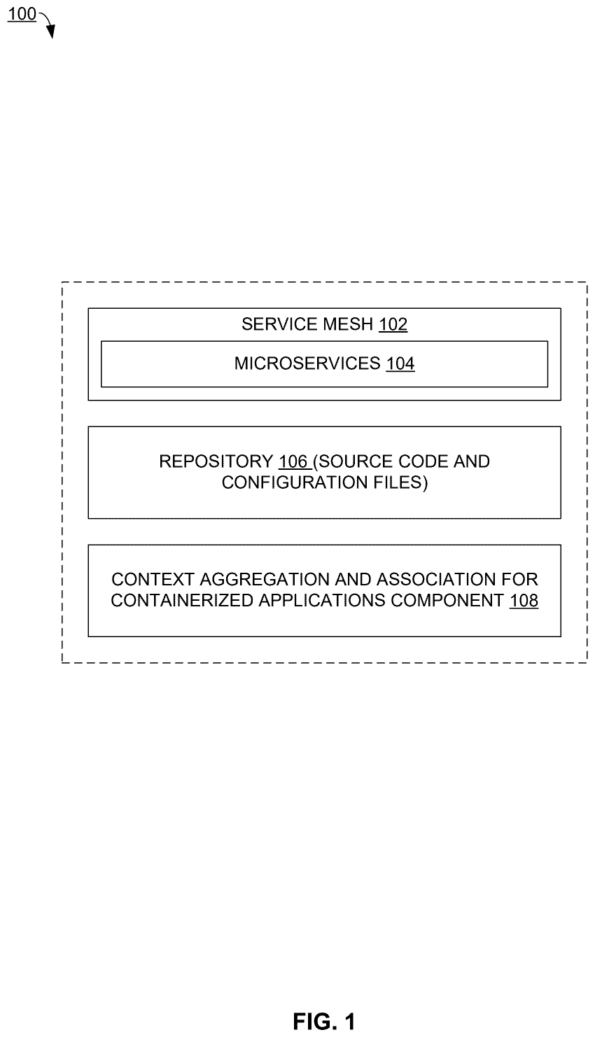

FIG. 1 illustrates an example system architecture 100 that can facilitate context aggregation and association for containerized applications, in accordance with an embodiment of this disclosure.

System architecture 100 comprises service mesh 102, microservices 104, repository 106 (source code and configuration files), and context aggregation and association for containerized applications component 108.

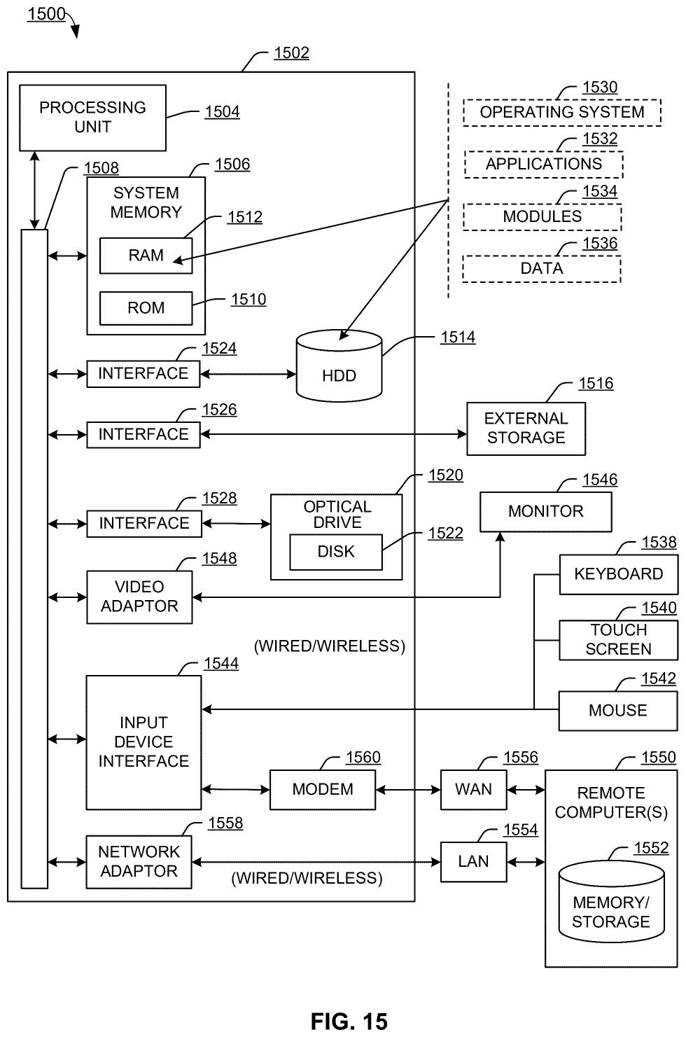

System architecture 100 can be implemented with part(s) of computing environment 1500 of FIG. 15.

Context aggregation and association for containerized applications component 108 can facilitate visualizing dependencies among microservices 104 of service mesh 102, as well as dependencies of those microservices on other resources, such as databases. In effectuating this, Context aggregation and association for containerized applications component 108 can perform static analysis on source code and configuration files of repository 106 (source code and configuration files) to determine the dependencies. For example, the configuration files can be parsed to identify key-value pairs that identify resources (e.g., microservices or databases), and the source code can be parsed to identify which microservices invoke which resources (thereby creating a dependency of the microservice on the resource).

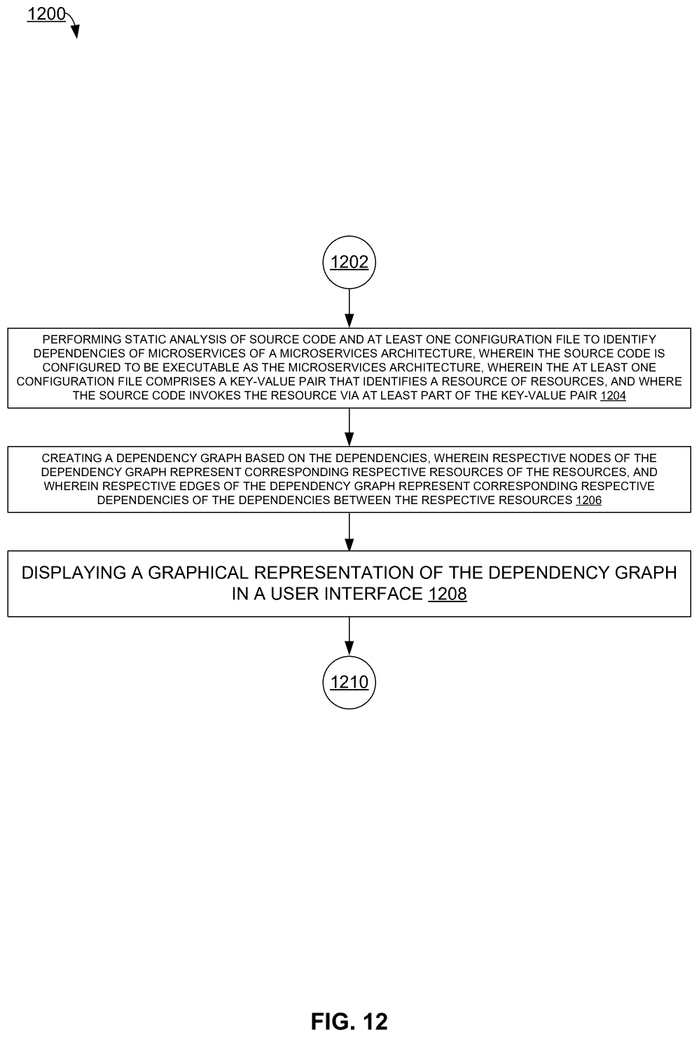

In some examples, context aggregation and association for containerized applications component 108 can implement part(s) of the process flows of FIGS. 12-14 to facilitate context aggregation and association for containerized applications.

It can be appreciated that system architecture 100 is one example system architecture for context aggregation and association for containerized applications, and that there can be other system architectures that facilitate context aggregation and association for containerized applications.

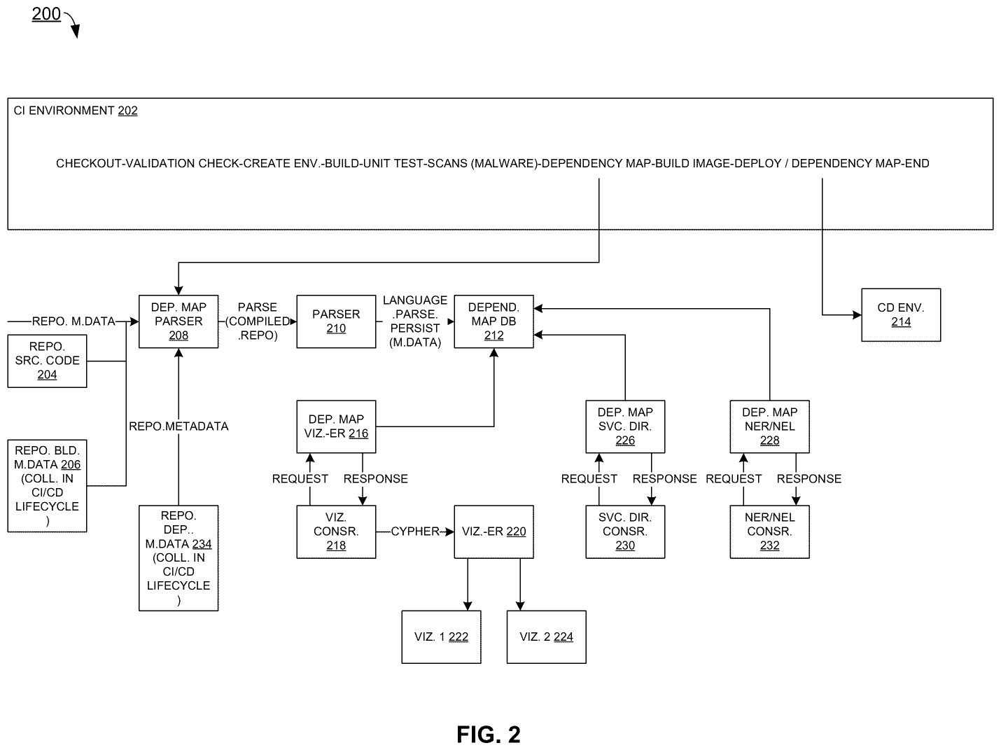

FIG. 2 illustrates another example system architecture 200 that can facilitate context aggregation and association for containerized applications, in accordance with an embodiment of this disclosure. In some examples, part(s) of system architecture 200 can be used by part(s) of system architecture 100 of FIG. 1 to facilitate context aggregation and association for containerized applications.

System architecture 200 comprises CI environment 202, repository source code 204, repository build metadata 206 (collected during CI/CD lifecycle), dependency map parser 208, parser 210, dependency map database 212 CD, environment 214, dependency map visualizer 216, visualizer consumer 218, visualizer 220, visualization 1 222, visualization 2 224, dependency map service directory 226, dependency map named entity recognition/named entity linking (NER/NEL) 228, service directory consumer 230, and NER/NEL consumer 232, and repository build metadata 234 (collected during CI/CD lifecycle).

The artifacts (in some examples, this can be human-written source code, the Java-language files generated during build from JavaScript Object Notation (JSON) files, configuration files like application.properties, and/or Yet Another Markup Language (YAML) files) can be sent to the dependency map parser, and the dependency metadata from a continuous integration (CI) build can be stored in the dependency map database. Another component is the visualizer, and it can a send dependency map payload (which can be in a JSON format) to the visualizer consumer that was built, and finally displayed in the browser.

A dependency map according to the present techniques can facilitate zero provisioning of physical/virtual hardware, zero physical deployments of microservice binaries, and thus zero physical binary executions to view dependencies between microservices and their software resources being consumed (e.g., databases, streaming event servers, etc.). This can be considered a proactive approach.

In contrast to a proactive approach, a reactive approach can require binaries (that is, software executables) being provisioned in an environment and execution events in order to illustrate their dependencies.

Differences between the present techniques and prior approaches can be as follows.
Approach and inputs:
   The present techniques: parsing source code to capture intentions
   Prior approaches: observing network traffic or accessing artifacts/configurations within containerized applications
Scope of the subject matter:
   The present techniques: extendable to be a knowledge graph with any concept/artifact in a developer's intention, and can be combined with metrics/artifacts observable within containerized applications
   Prior approaches: observing network traffic or accessing artifacts/configurations within containerized applications
When to generate a dependency map:
   The present techniques: For each release, a build can be performed, so A/B testing can be supported when different builds coexist in containerized applications
   Prior approaches: Only after behaviors/configurations are performed in containerized applications
Intention vs. results:
   The present techniques: A focus of the application containers can be observed, and can be combined with results from observable metrics/artifacts observable within containerized applications
   Prior approaches: Only on the results observable within containerized applications
Abstraction level:
   The present techniques: Custom application levels with source code available, can be combined with metrics/artifacts observable within containerized applications as results
   Prior approaches: Focus on observable containers' behavior and accessible metrics/configurations
Association to other information sources:
   The present techniques: Other information (e.g., definition of error codes, infrastructure concepts, design patterns) can be included where there are parsers for those entities
   Prior approaches: Cannot easily be connected to other information sources

The present techniques can offer various advantages relative to prior approaches. A dependency map according to the present techniques can increase an efficiency of a site reliability engineer (SRE) by providing them with full context information (e.g., which release, which environment, which services and how they should work together to achieve a task). It can also reduce a time needed for source code data retrieval from isolated code repositories. It can also aid in coordinating and designing properly across different application teams, since it can be that everyone can easily know the current business logic implemented in a containerized application platform.

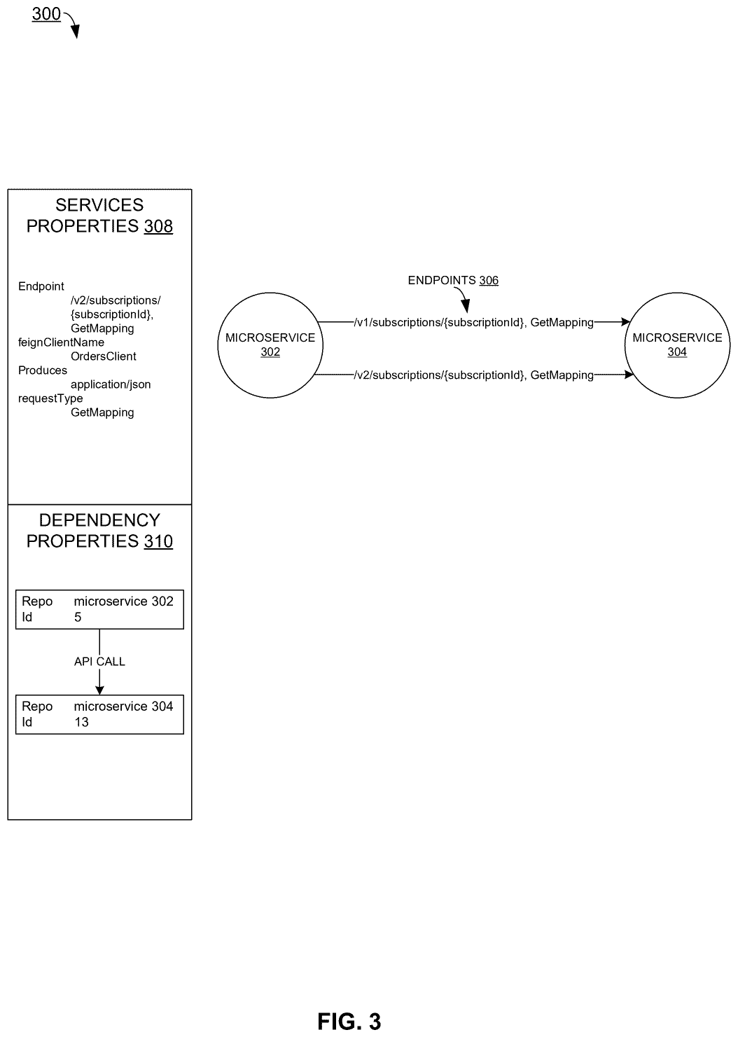

FIG. 3 illustrates an example dependency graph 300 that can facilitate context aggregation and association for containerized applications, in accordance with an embodiment of this disclosure. In some examples, part(s) of dependency graph 300 can be used by part(s) of system architecture 100 of FIG. 1 to facilitate context aggregation and association for containerized applications.

Dependency graph 300 comprises microservice 302, microservice 304, endpoints 306, services properties 308, and dependency properties 310.

Each node can be a microservice (or a resource/entity) that is identified from source code and/or a configuration file.

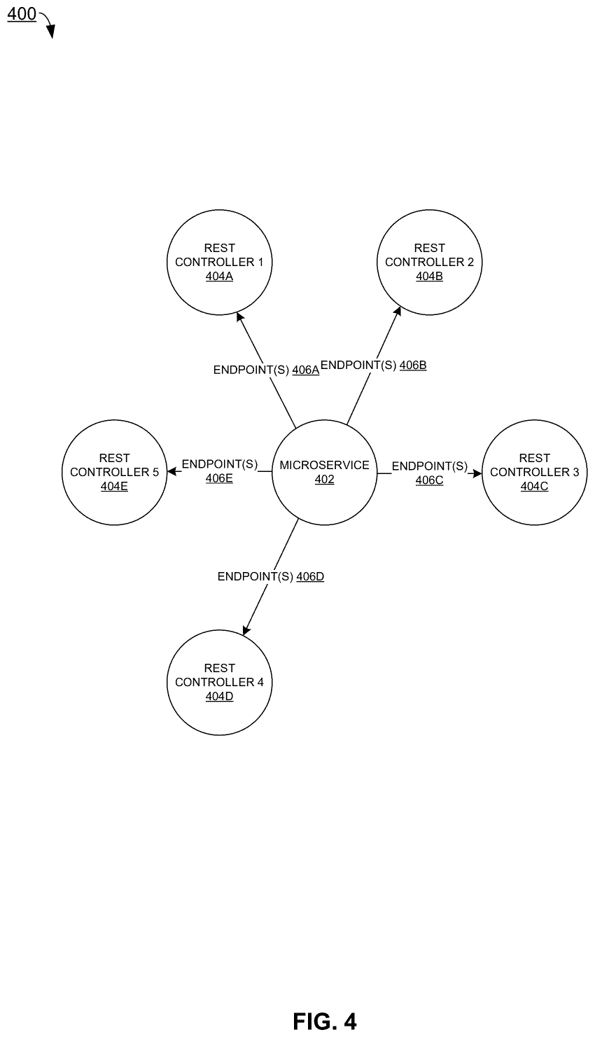

FIG. 4 illustrates an example dependency graph 400 that can facilitate context aggregation and association for containerized applications, in accordance with an embodiment of this disclosure. In some examples, part(s) of dependency graph 400 can be used by part(s) of system architecture 100 of FIG. 1 to facilitate context aggregation and association for containerized applications.

Dependency graph 400 comprises microservice 402, REST controller 1 404A, REST controller 2 404B, REST controller 3 404C, REST controller 4 404D, REST controller 5 404E, endpoint(s) 406A, endpoint(s) 406B, endpoint(s) 406C, endpoint(s) 406D, and endpoint(s) 406E.

REST controllers for microservices can be expressed as different nodes.

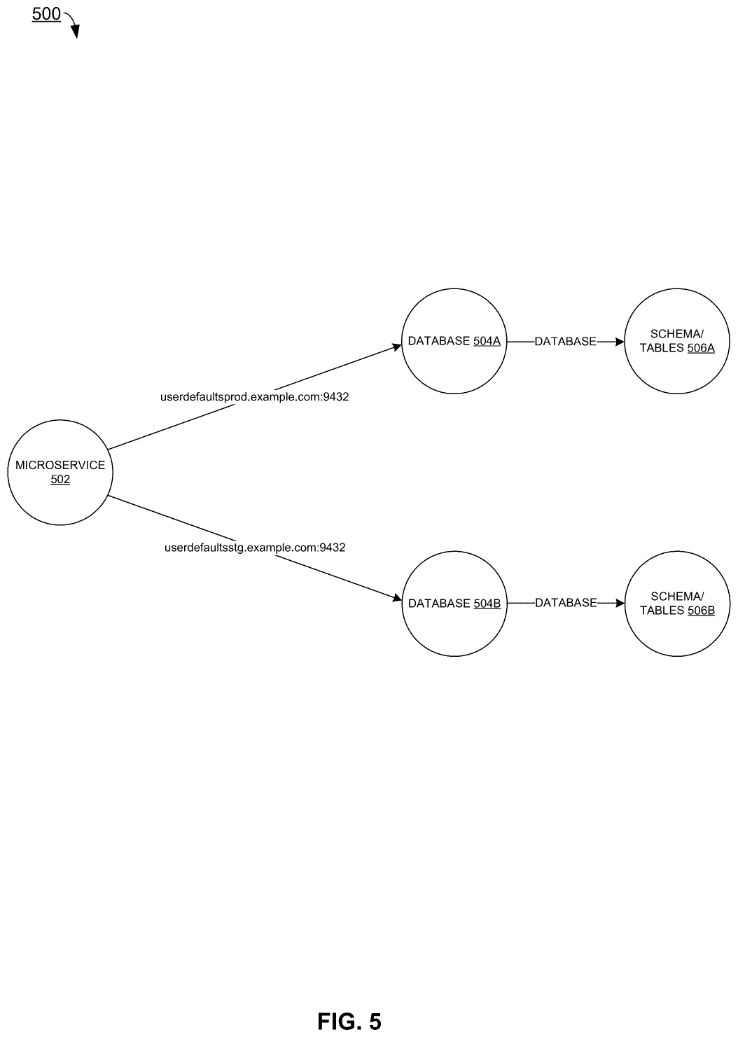

FIG. 5 illustrates an example dependency graph 500 that can facilitate context aggregation and association for containerized applications, in accordance with an embodiment of this disclosure. In some examples, part(s) of dependency graph 500 can be used by part(s) of system architecture 100 of FIG. 1 to facilitate context aggregation and association for containerized applications.

Dependency graph 500 comprises microservice 502, database 504A, database 504B, schema/tables 506A, and schema/tables 506B.

Database servers and tables can be captured as nodes.

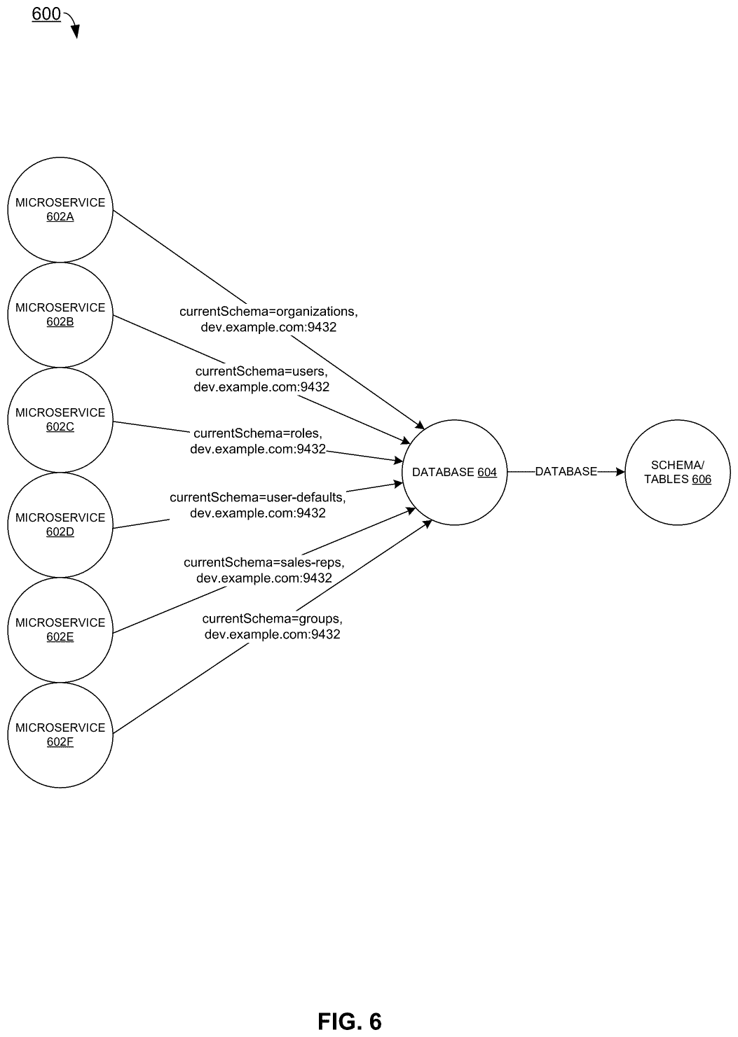

FIG. 6 illustrates an example dependency graph 600 that can facilitate context aggregation and association for containerized applications, in accordance with an embodiment of this disclosure. In some examples, part(s) of dependency graph 600 can be used by part(s) of system architecture 100 of FIG. 1 to facilitate context aggregation and association for containerized applications.

Dependency graph 600 comprises microservice 602A, microservice 602B, microservice 602C, microservice 602D, microservice 602E, microservice 602F, database 604, and schema/tables 606.

There can be multiple microservices that depend on the same database.

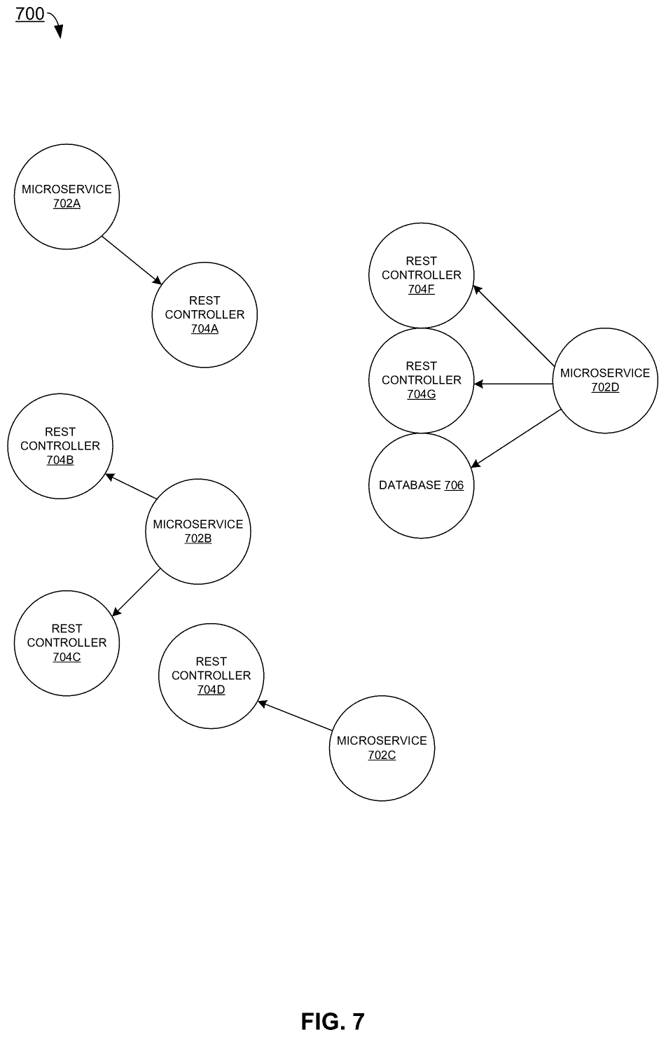

FIG. 7 illustrates an example dependency graph 700 that can facilitate context aggregation and association for containerized applications, in accordance with an embodiment of this disclosure. In some examples, part(s) of dependency graph 700 can be used by part(s) of system architecture 100 of FIG. 1 to facilitate context aggregation and association for containerized applications.

Dependency map graph comprises microservice 702A, microservice 702B, microservice 702C, microservice 702D, REST controller 704A, REST controller 704B, REST controller 704C, REST controller 704D, REST controller 704F, REST controller 704G, and database 706.

Zooming in and zooming out on a dependency map can be performed.

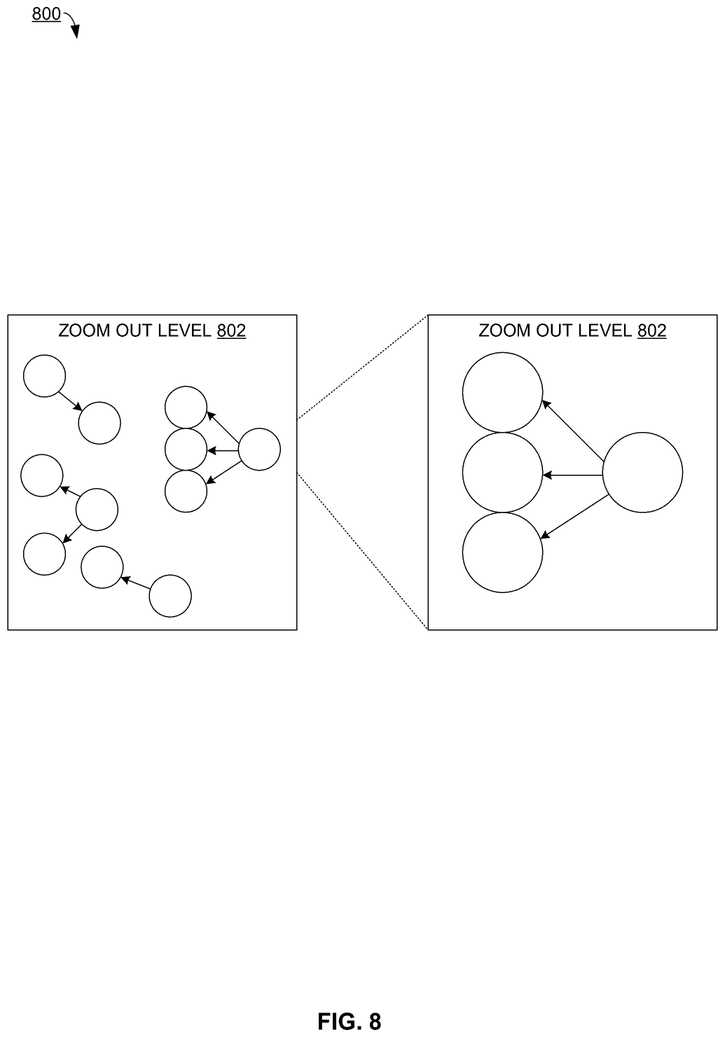

FIG. 8 illustrates an example dependency graph 800 that can facilitate context aggregation and association for containerized applications, in accordance with an embodiment of this disclosure. In some examples, part(s) of dependency graph 800 can be used by part(s) of system architecture 100 of FIG. 1 to facilitate context aggregation and association for containerized applications.

A full execution cycle/path can be traced, and different levels of zooming in can be performed.

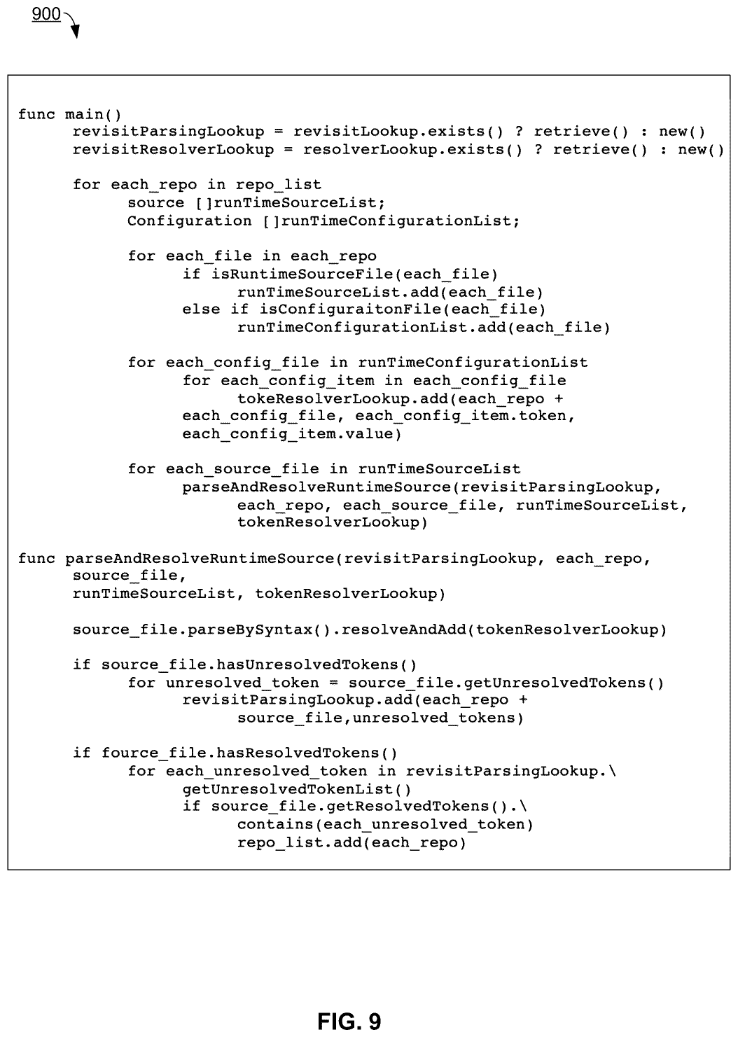

FIG. 9 illustrates example pseudo code 900 that can facilitate context aggregation and association for containerized applications, in accordance with an embodiment of this disclosure. In some examples, part(s) of pseudo code 900 can be used by part(s) of system architecture 100 of FIG. 1 to facilitate context aggregation and association for containerized applications.

The following data structures can be implemented in pseudo code 900:
revisitParsingLookup: contains the tuple pair source filename and the token that did not have a concrete value
tokenResolverLookup: contains the tuple pair token and concrete value. A concrete value can be a literal. At times, this can be a syntax of an environment variable, while still considered the considered the literal. In some examples, these types of formals can be keys in a secure vault.
runTimeSourceList: contains a list of source code for a given microservice that can be executed at runtime.
runTimeConfigurationList: contains runtime configuration key/value pairs

In pseudo code 900, source file classification can be performed as follows. Each source file, from a parsing point of view, can be classified as runtime source file or configuration file, such as based on these example characteristics:
Runtime source file:
   Determined by filename extension
   Determined by syntax in file (Java, Python, Go, etc.)
   Directory naming
Configuration file:
   Determined by filename extension
   Determined by syntax (e.g., “Key=value” or “Key: value”)
   Directory naming

In pseudo code 900, identifying information in a configuration file can be captured in an example configuration tuple of source-key-value:
Source: when two keys are the same but from different sources, this value can help in disambiguating
Key: a token found in a configuration file that can be referenced in a runtime source file
Value: an actual value can be fully known (e.g., a syntactically correct domain name for a database, or a variable value
Additional markup around the value can mean that the actual value is known elsewhere (e.g., environment variable on deployed system, or the value is known in a vault for security purposes)

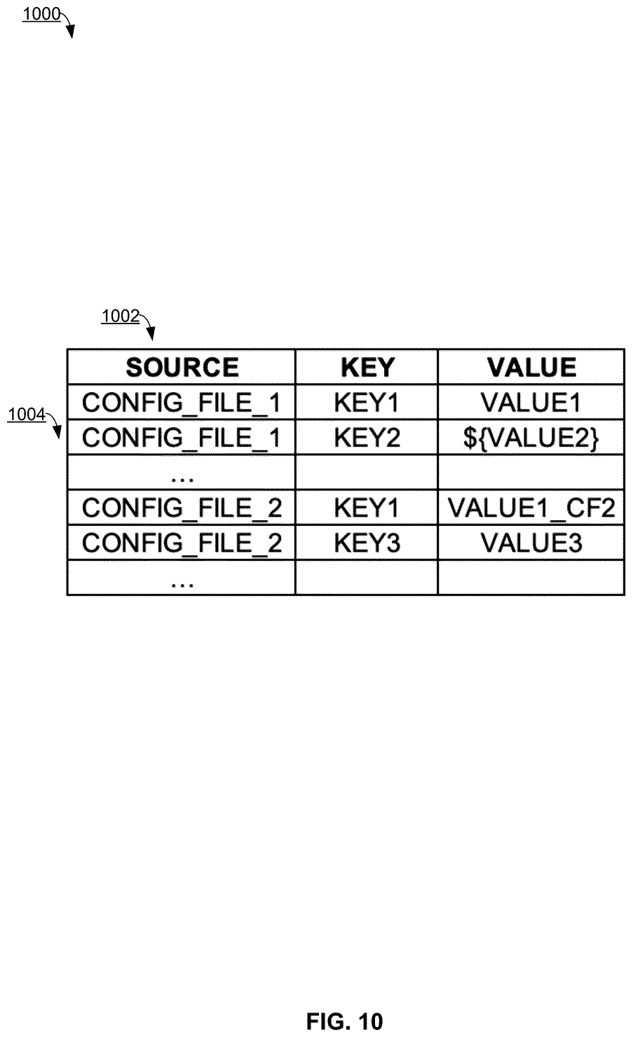

Configuration table 1000 of FIG. 10 can show example extracted configuration values (such as with a tokenResolverLookup of pseudo code 900).

Parsing source code can be performed as follows:
Primary parsing:
   Parse for key/value for configurations
   Configurations can be the glue between current service and external services/databases/key vaults, etc.
Secondary parsing (which can find metadata for operations that “really happen” as opposed to desired operations):
   Syntax for microservice endpoints, database create-read-update-delete (CRUD), database tables/columns, streaming events consumer/producer (group-id, topic-id), streaming events server endpoint, method to method invocation, class declaration usage, etc.

In pseudo code 900, there can be a method takes the given source file and parses for particular syntax that implies a configuration file key/token, external resource usage (another microservice, database, streaming event producer/consumer/server, vault key, etc.).

In pseudo code 900, the content of the tokenResolverLookup table (e.g., configuration table 1000 of FIG. 10) can be used to resolve keys declared in source code. It can be that, at the time of the execution for parsing there may be keys whose values have not been resolved themselves. In such examples, unresolved tokens can be added for future resolution.

As a current source file is parsed, the usage of key and value can be resolved. A check can be made against unresolved tokens, and if found then the repo can be added back into the repo_list to be reparsed (for resolution).

A repository and runtime source file example can be as follows:
Given time A<time B,
   At time A, repo_A has syntax that represents an endpoint
   /some_microservice/some_uri/{dynamic_value}
   At time A, /some_microservice is not known
At time B, repo_B contains syntax declares itself as/some_microservice
At time B+1, /some_microservice is found to be unresolved by repo_A and then repo_A is added back into the repo_list to be reparsed.

FIG. 10 illustrates an example configuration table 1000 that can facilitate context aggregation and association for containerized applications, in accordance with an embodiment of this disclosure. In some examples, part(s) of configuration table 1000 can be used by part(s) of system architecture 100 of FIG. 1 to facilitate context aggregation and association for containerized applications.

Configuration table 1000 comprises columns 1002 and rows 1004.

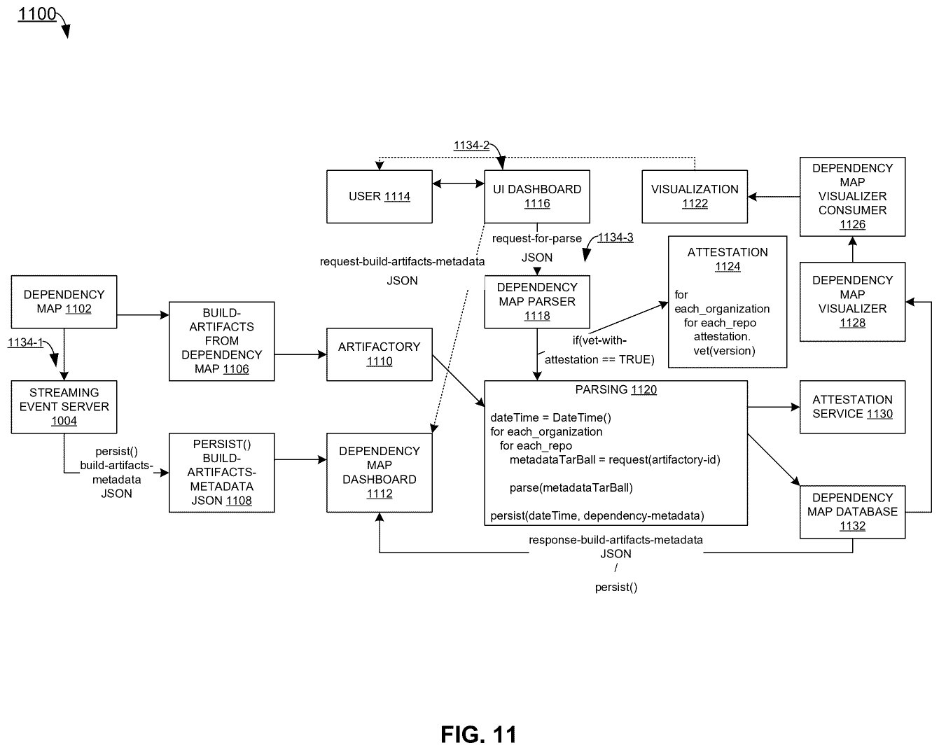

FIG. 11 illustrates another example system architecture 1100 that can facilitate context aggregation and association for containerized applications, in accordance with an embodiment of this disclosure. In some examples, part(s) of system architecture 1100 can be used by part(s) of system architecture 100 of FIG. 1 to facilitate context aggregation and association for containerized applications.

System architecture 1100 comprises dependency map 1102, streaming event server 1104, build-artifacts from dependency map 1106, persist ( ) build-artifacts-metadata JSON 1108, artifactory 1110, dependency map dashboard 1112, user 1114, UI dashboard 1116, dependency map parser 1118, parsing 1120, visualization 1122, attestation 1124, dependency map visualizer consumer 1126, dependency map visualizer 1128, attestation service 1130, and dependency map database 1132.

At 1134-1, developers can commit/push merge to main branches of various repositories throughout a development lifecycle.

At 1134-2, a developer can request what has been built.

At 1134-3, a developer can review dependencies of one or more organizations along with one or more services (and, in some examples, one or more versions of a single microservice).

A dependency map database can contain dependency metadata.

At 1136-A, a sample payload (in a JavaScipt Object Notation (JSON) format) for built artifacts metadata can be:

```
{
  “organization-name”: “...”,
  “respositoryname”: “...”,
  “version”: “...”,
  “date-time”: “...”,
  “artifactory-id”: “...”
}
```

At 1136-B, a sample payload (in a JSON format) for a request for built artifacts metadata can be:

```
{
  “start-date”: “...”,
  “end-date”: “...”
}
```

At 1136-C, a sample payload (in a JSON format) for a response for built artifacts metadata can be:

```
[
  {
    “organization-name”: “org_1”
    “repositorynames”: [
      {
        “repositoryname”: “...”,
        “version”: “...”,
        “data-time”: “...”,
        “artifactory-id”: “art_1_1”
      },
      {
        ...
      },
        ...
    ],
  },
  {
    “organization-name”: “org_2”
    “repositorynames”: [
      {
        “repositoryname”: “...”,
        “version”: “...”,
        “data-time”: “...”,
        “artifactory-id”: “art_2_1”
      },
      {
        ...
      },
      ...
    ],
  },
]
```

At 1136-D, a sample payload (in a JSON format) for a request for parse can be:

```
{
  “environment”: development/staging/pre-prod/prod/etc,
  “vet-with-attestation”: true/false,
  “description”: <STRING>,
  “parse-list”: [
    {
      “organization-name”: “org_1”
      “reponames”: [
        “artifactory-id”: “art_1_1”,
        “artifactory-id”: “art_1_2”,
        “artifactory-id”: “art_1_3”,
        “artifactory-id”: “art_1_4”,
        ...
      ],
    },
    {
      “organization-name”: “org_2”
      “reponames”: [
        “artifactory-id”: “art_2_1”,
        “artifactory-id”: “art_2_2”,
        “artifactory-id”: “art_2_3”,
        “artifactory-id”: “art_2_4”,
        ...
      ],
    },
  ]
}
```

### Example Process Flows

FIG. 12 illustrates an example process flow 1200 for context aggregation and association for containerized applications, in accordance with an embodiment of this disclosure. In some examples, one or more embodiments of process flow 1200 can be implemented by system architecture 100 of FIG. 1, or computing environment 1500 of FIG. 15.

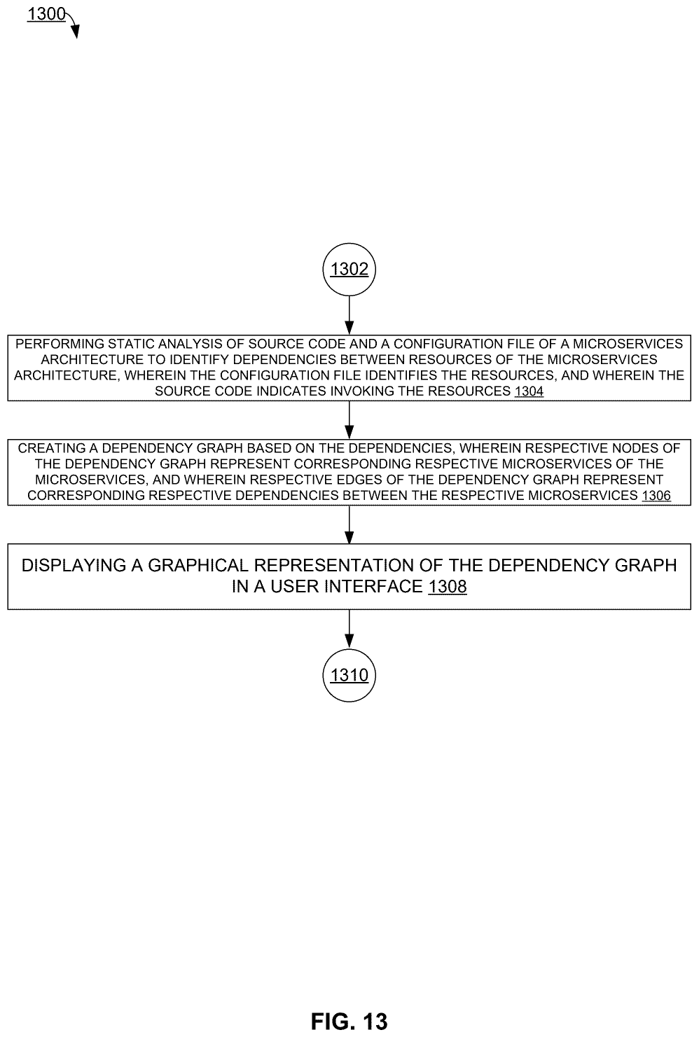

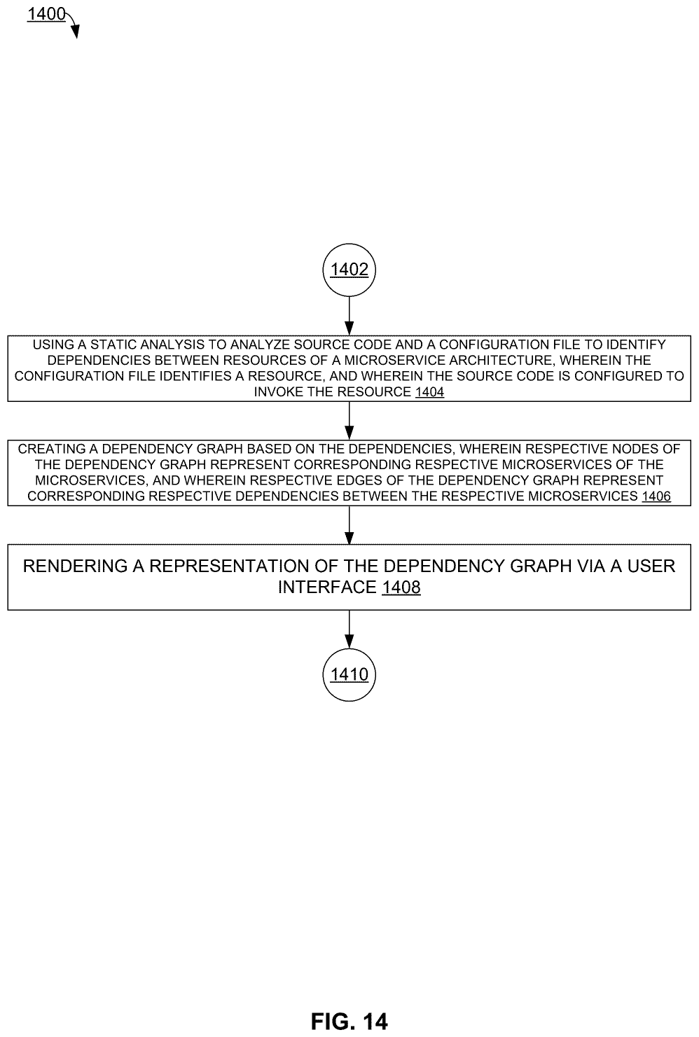

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of one or more of process flow 1300 of FIG. 13 and/or process flow 1400 of FIG. 14.

Process flow 1200 begins with 1202, and moves to operation 1204.

Operation 1204 depicts performing static analysis of source code and at least one configuration file to identify dependencies of microservices of a microservices architecture, wherein the source code is configured to be executable as the microservices architecture, wherein the at least one configuration file comprises a key-value pair that identifies a resource of resources, and where the source code invokes the resource via at least part of the key-value pair. Using the example of FIG. 1, the static analysis can be performed on repository 106 (source code and configuration files).

In some examples, the performing of the static analysis is performed independently of provisioning physical hardware or virtual hardware. In some examples, the performing of the static analysis is performed independently of deploying at least part of the source code. That is, the present techniques can be implemented to create a dependency map without provisioning physical and/or virtual hardware, without any physical deployments of microservices binaries, and without any physical binary executions.

In some examples, the resources comprise the microservices. That is, one microservice can depend on another microservice, via making a call to that microservice.

After operation 1204, process flow 1200 moves to operation 1206.

Operation 1206 depicts creating a dependency graph based on the dependencies, wherein respective nodes of the dependency graph represent corresponding respective resources of the resources, and wherein respective edges of the dependency graph represent corresponding respective dependencies of the dependencies between the respective resources. This can be a dependency graph such as one illustrated in FIGS. 3-8.

In some examples, the respective edges are directional, and wherein a first edge of the respective edges indicates that a first node of the respective nodes depends from a second node of the respective nodes. That is, a dependency map can have directional edges to indicate which resource depends on which other resource.

In some examples, the dependency graph is created in a human-readable text format. For example, the dependency graph can be expressed in a JSON format.

After operation 1206, process flow 1200 moves to operation 1208.

Operation 1208 depicts displaying a graphical representation of the dependency graph in a user interface. This can be a dependency graph such as one illustrated in FIGS. 3-8.

In some examples, the performing, the creating, and the displaying are performed as part of a continuous integration and continuous deployment pipeline. That is, the present techniques can be integrated into a pipeline of a CI/CD component.

In some examples, the performing, the creating, and the displaying are performed after a malware scan of the continuous integration and continuous deployment pipeline and before building a container image based on the source code in the continuous integration and continuous deployment pipeline. That is, the present techniques can be implemented in a part of a pipeline of a CI/CD component similar to as indicated with respect to FIG. 2.

In some examples, the performing, the creating, and the displaying are performed based on at least part of the source code being committed to a repository. That is, performing the present techniques can be triggered based on code being committed to a repository.

After operation 1208, process flow 1200 moves to 1210, where process flow 1200 ends.

FIG. 13 illustrates an example process flow 1300 for context aggregation and association for containerized applications, in accordance with an embodiment of this disclosure. In some examples, one or more embodiments of process flow 1300 can be implemented by system architecture 100 of FIG. 1, or computing environment 1500 of FIG. 15.

It can be appreciated that the operating procedures of process flow 1300 are example operating procedures, and that there can be embodiments that implement more or fewer operating procedures than are depicted, or that implement the depicted operating procedures in a different order than as depicted. In some examples, process flow 1300 can be implemented in conjunction with one or more embodiments of one or more of process flow 1200 of FIG. 12 and/or process flow 1400 of FIG. 14.

Process flow 1300 begins with 1302, and moves to operation 1304.

Operation 1304 depicts performing static analysis of source code and a configuration file of a microservices architecture to identify dependencies between resources of the microservices architecture, wherein the configuration file identifies the resources, and wherein the source code indicates invoking the resources. In some examples, operation 1304 can be implemented in a similar manner as operation 1204 of FIG. 12.

After operation 1304, process flow 1300 moves to operation 1306.

Operation 1306 depicts creating a dependency graph based on the dependencies, wherein respective nodes of the dependency graph represent corresponding respective microservices of the microservices, and wherein respective edges of the dependency graph represent corresponding respective dependencies between the respective microservices. In some examples, operation 1306 can be implemented in a similar manner as operation 1206 of FIG. 12.

In some examples, a first node of the dependency graph represents a representational state transfer application programming interface that a microservice of the microservices is configured to invoke, and an edge between the first node and a second node that corresponds to the microservice represents a call to the representational state transfer application programming interface by the microservice. This can be similar to what is depicted in FIG. 4.

In some examples, a first node of the dependency graph represents a database that a microservice of the microservices is configured to access, and an edge between the first node and a second node that corresponds to the microservice represents a configuration to the database. In some examples, the edge is a first edge, a third node of the dependency graph represents a database schema, and a second edge between the first node and the second node represents that the database schema is used by the database. This can be similar to what is depicted in FIG. 5.

After operation 1306, process flow 1300 moves to operation 1308.

Operation 1308 depicts displaying a graphical representation of the dependency graph in a user interface. In some examples, operation 1308 can be implemented in a similar manner as operation 1208 of FIG. 12.

In some examples, the displaying of the graphical representation comprises displaying properties of at least one microservice of the microservices. This can be similar to services properties 308 of FIG. 3.

In some examples, the displaying of the graphical representation comprises displaying properties of a dependency of the dependencies. This can be similar to dependency properties 310.

After operation 1308, process flow 1300 moves to 1310, where process flow 1300 ends.

FIG. 14 illustrates an example process flow 1400 for context aggregation and association for containerized applications, in accordance with an embodiment of this disclosure. In some examples, one or more embodiments of process flow 1400 can be implemented by system architecture 100 of FIG. 1, or computing environment 1500 of FIG. 15.

It can be appreciated that the operating procedures of process flow 1400 are example operating procedures, and that there can be embodiments that implement more or fewer operating procedures than are depicted, or that implement the depicted operating procedures in a different order than as depicted. In some examples, process flow 1400 can be implemented in conjunction with one or more embodiments of one or more of process flow 1200 of FIG. 12 and/or process flow 1300 of FIG. 13.

Process flow 1400 begins with 1402, and moves to operation 1404.

Operation 1404 depicts using a static analysis to analyze source code and a configuration file to identify dependencies between resources of a microservice architecture, wherein the configuration file identifies a resource, and wherein the source code is configured to invoke the resource. In some examples, operation 1404 can be implemented in a similar manner as operation 1204 of FIG. 12.

In some examples, using the static analysis comprises using a result of determining whether a file is a runtime source file or a configuration file based on a filename extension of the file, a syntax in the file, or a directory name of a directory that houses the file

In some examples, using the static analysis comprises performing a primary parsing of a runtime source file of the source code for key-value configurations.

In some examples, using the static analysis comprises performing a secondary parsing of the runtime source file of the source code for a syntax for a microservice endpoint, a database create, read, update, or delete operation, a method-to-method invocation, or a programming language class declaration usage.

After operation 1404, process flow 1400 moves to operation 1406.

Operation 1406 depicts creating a dependency graph based on the dependencies, wherein respective nodes of the dependency graph represent corresponding respective microservices of the microservices, and wherein respective edges of the dependency graph represent corresponding respective dependencies between the respective microservices. In some examples, operation 1406 can be implemented in a similar manner as operation 1206 of FIG. 12.

After operation 1406, process flow 1400 moves to operation 1408.

Operation 1408 depicts rendering a representation of the dependency graph via a user interface. In some examples, operation 1408 can be implemented in a similar manner as operation 1208 of FIG. 12.

In some examples, operation 1408 comprises modifying a zoom level of the representation of the dependency graph rendered via the user interface based on receiving user input data indicative of the modifying of the zoom level. This can be implemented in a similar manner as depicted in FIGS. 7-8.

After operation 1408, process flow 1400 moves to 1410, where process flow 1400 ends.

### Example Operating Environment

In order to provide additional context for various embodiments described herein, FIG. 15 and the following discussion are intended to provide a brief, general description of a suitable computing environment 1500 in which the various embodiments of the embodiment described herein can be implemented.

For example, parts of computing environment 1500 can be used to implement one or more embodiments of system architecture 100 of FIG. 1.

In some examples, computing environment 1500 can implement one or more embodiments of the process flows of FIGS. 12-14 to facilitate context aggregation and association for containerized applications.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 15, the example environment 1500 for implementing various embodiments described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a nonvolatile storage such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), one or more external storage devices 1516 (e.g., a magnetic floppy disk drive (FDD) 1516, a memory stick or flash drive reader, a memory card reader, etc.) and an optical disk drive 1520 (e.g., which can read or write from a CD-ROM disc, a DVD, a BD, etc.). While the internal HDD 1514 is illustrated as located within the computer 1502, the internal HDD 1514 can also be configured for external use in a suitable chassis (not shown). Additionally, while not shown in environment 1500, a solid state drive (SSD) could be used in addition to, or in place of, an HDD 1514. The HDD 1514, external storage device(s) 1516 and optical disk drive 1520 can be connected to the system bus 1508 by an HDD interface 1524, an external storage interface 1526 and an optical drive interface 1528, respectively. The interface 1524 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1394 serial port, a game port, a USB port, an IR interface, a BLUETOOTH® interface, etc.

A monitor 1546 or other type of display device can be also connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired and/or wireless communications to one or more remote computers, such as a remote computer(s) 1550. The remote computer(s) 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 and/or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 can be connected to the local network 1554 through a wired and/or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the Internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. It will be appreciated that the network connections shown are examples, and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 and/or modem 1560, manage storage provided by the cloud storage system as it would other types of external storage. For instance, the external storage interface 1516 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
performing static analysis of source code and at least one configuration file to identify dependencies of microservices of a microservices architecture, wherein the source code is configured to be executable as the microservices architecture, wherein the at least one configuration file comprises a key-value pair that identifies a resource of resources, and where the source code invokes the resource via at least part of the key-value pair;
creating a dependency graph based on the dependencies, wherein respective nodes of the dependency graph represent corresponding respective resources of the resources, and wherein respective edges of the dependency graph represent corresponding respective dependencies of the dependencies between the respective resources; and
displaying a graphical representation of the dependency graph in a user interface.

2. The system of claim 1, wherein the performing of the static analysis is performed independently of provisioning physical hardware or virtual hardware.

3. The system of claim 1, wherein the performing of the static analysis is performed independently of deploying at least part of the source code.

4. The system of claim 1, wherein the respective edges are directional, and wherein a first edge of the respective edges indicates that a first node of the respective nodes depends from a second node of the respective nodes.

5. The system of claim 1, wherein the resources comprise the microservices.

6. The system of claim 1, wherein the dependency graph is created in a human-readable text format.

7. The system of claim 1, wherein the performing, the creating, and the displaying are performed as part of a continuous integration and continuous deployment pipeline.

8. The system of claim 7, wherein the performing, the creating, and the displaying are performed after a malware scan of the continuous integration and continuous deployment pipeline and before building a container image based on the source code in the continuous integration and continuous deployment pipeline.

9. The system of claim 7, wherein the performing, the creating, and the displaying are performed based on at least part of the source code being committed to a repository.

10. A method, comprising:
performing, by a system comprising at least one processor, static analysis of source code and a configuration file of a microservices architecture to identify dependencies between resources of the microservices architecture, wherein the configuration file identifies the resources, and wherein the source code indicates invoking the resources;
creating, by the system, a dependency graph based on the dependencies, wherein respective nodes of the dependency graph represent corresponding respective microservices of the microservices, and wherein respective edges of the dependency graph represent corresponding respective dependencies between the respective microservices; and
displaying, by the system, a graphical representation of the dependency graph in a user interface.

11. The method of claim 8, wherein the displaying of the graphical representation comprises:
displaying properties of at least one microservice of the microservices.

12. The method of claim 8, wherein the displaying of the graphical representation comprises:
displaying properties of a dependency of the dependencies.

13. The method of claim 8, wherein a first node of the dependency graph represents a representational state transfer application programming interface that a microservice of the microservices is configured to invoke, and
wherein an edge between the first node and a second node that corresponds to the microservice represents a call to the representational state transfer application programming interface by the microservice.

14. The method of claim 8, wherein a first node of the dependency graph represents a database that a microservice of the microservices is configured to access, and wherein an edge between the first node and a second node that corresponds to the microservice represents a configuration to the database.

15. The method of claim 14, wherein the edge is a first edge, wherein a third node of the dependency graph represents a database schema, and wherein a second edge between the first node and the second node represents that the database schema is used by the database.

16. A non-transitory computer-readable medium comprising instructions that, in response to execution, cause a system comprising at least one processor to perform operations, comprising:
using a static analysis to analyze source code and a configuration file to identify dependencies between resources of a microservice architecture, wherein the configuration file identifies a resource, and wherein the source code is configured to invoke the resource;
creating a dependency graph based on the dependencies, wherein respective nodes of the dependency graph represent corresponding respective microservices of the microservices, and wherein respective edges of the dependency graph represent corresponding respective dependencies between the respective microservices; and
rendering a representation of the dependency graph via a user interface.

17. The non-transitory computer-readable medium of claim 16, wherein the operations further comprise:
modifying a zoom level of the representation of the dependency graph rendered via the user interface based on receiving user input data indicative of the modifying of the zoom level.

18. The non-transitory computer-readable medium of claim 16, wherein using the static analysis comprises using a result of determining whether a file is a runtime source file or a configuration file based on a filename extension of the file, a syntax in the file, or a directory name of a directory that houses the file.

19. The non-transitory computer-readable medium of claim 16, wherein using the static analysis comprises:
performing a primary parsing of a runtime source file of the source code for key-value configurations.

20. The non-transitory computer-readable medium of claim 19, wherein using the static analysis further comprises:
performing a secondary parsing of the runtime source file of the source code for:
syntax for a microservice endpoint,
a database create, read, update, or delete operation,
a method-to-method invocation, or
a programming language class declaration usage.
